(19) United States
(12) Patent Application Publication
(10) Pub. No.: US 2017/0334782 A1
(43) Pub. Date: Nov. 23, 2017

(54) FIRE RESISTANT CALCIUM SULPHATE-BASED PRODUCTS

(71) Applicant: SAINT-GOBAIN PLACO, Suresnes (FR)

(72) Inventors: Laura BROOKS, Loughborough (GB); Robin FISHER, Loughborough (GB); Jan RIDEOUT, Loughborough (GB)

(73) Assignee: SAINT-GOBAIN PLACO, Suresnes (FR)

(21) Appl. No.: 15/524,127

(22) PCT Filed: Nov. 17, 2015
(86) PCT No.: PCT/EP2015/076788

§ 371 Date: May 3, 2017

(30) Foreign Application Priority Data
Nov. 21, 2014 (GB) 1420770.8

(51) Int. Cl. C04B 28/14; C01F 11/46; C04B 111/28; C08G 77/04; C04B 111/00

(52) U.S. Cl. CPC C04B 28/14; C01F 11/46; C04B 2111/00612; C08G 77/04; C04B 2111/28

(57) ABSTRACT

The present invention provides a calcium sulphate-based product (e.g. a wall board) comprising gypsum and silicone oil. The product may be produced by drying an aqueous slurry comprising calcined gypsum and the silicone oil. The silicone oil is included in the slurry in an amount greater than 10 wt % which results in a product have greater than 8.5 wt % silicone oil. This improves structural integrity of the wallboard after exposure to elevated temperatures.

This invention relates to improved fire resistant calcium sulphate-based products and, in particular, to calcium sulphate-based building/construction products having improved strength after exposure to high temperatures.

### BACKGROUND

Calcium sulphate-based products are widely used in the construction of buildings, for example, to form internal partitions (using wallboard, also known as dry wall, gypsum board or plaster board) and ceilings or to encase ducts (e.g. ventilation ducts) within buildings.

Calcium sulphate-based products such as wallboard are typically formed by drying an aqueous slurry of the hemihydrate of calcium sulphate (CaSO₄.½H₂O), also known as calcined gypsum or stucco, between two sheets of lining paper or fibreglass matting. As the slurry dries and the calcined gypsum is hydrated, a hard, rigid core of gypsum (calcium sulphate dihydrate—(CaSO₄.2H₂O)) sandwiched between the lining sheets/mats is formed.

When wallboard is exposed to high temperatures such as those experienced in a building fire, or those experienced by wallboards used for encasing ducts carrying high temperature fluids, the water of crystallization contained within the gypsum is driven off to yield the anhydrite of calcium sulphate. Initially, this has the advantage that heat transfer across the wallboard is reduced thus helping to contain the heat emanating from a duct or generated during a building fire. However, at temperatures around 400-450° C., the initially formed AIII phase anhydrite (also known as γ-CaSO₄ or “soluble” anhydrite) converts to the AII phase (or “insoluble” anhydrite) and this phase change results in shrinkage of the wallboard i.e. a loss of dimensional stability. This shrinkage (which may be around 2% of the wallboard's length or width or around 6 vol %) often causes the wallboards to pull away from their supporting structures. This is obviously undesirable. In situations where wallboard is used for internal partitions and a fire breaks out, shrinkage can leaves gaps exposing rooms adjacent to the fire source to the effects of the heat/fire. Gaps also allow ingress of oxygen into the fire source thus fuelling the fire and negating the effects of any fire doors.

At higher temperatures (in excess of 600° C.), the insoluble anhydrite goes on to sinter resulting in large reductions in wallboard volume. This results in extreme shrinkage which eventually causes collapse of the internal walls/ceilings/duct casings as they are no longer held by their supporting structures.

Furthermore, once the chemical composition of the gypsum has been altered by the heat, the wallboard loses strength and, ultimately, structural integrity. Typically, the gypsum core of wallboard that has been exposed to high temperatures such as those generated during building fires crumbles to a fine dust and thus the wallboard effectively disintegrates.

Calcium sulphate-based products are also used to cast metal or glass objects. Calcium sulphate moulds are heated to 700-900° C. prior to being filled with molten metal/glass. It is important to control high temperature shrinkage of such calcium sulphate-based moulds to ensure that the moulds do not leak and to ensure that the cast metal/glass products are not warped.

It is known to include silicone oil in calcium sulphate based products in low amounts in order to improve the water-resistance of the product.

A preferred aim of the present invention is to provide an improved fire/heat resistant calcium-sulphate-based product having improved strength, hardness and structural integrity after heat exposure e.g. during a building fire. Such an improved fire resistant product may have particular use as a building product e.g. wallboard or panels for forming internal partitions in buildings, ceiling tiles, wallboard or panels for encasing ventilation/smoke extraction ducting, joint filler materials for joining wallboard/panels/tiles or for moulds for use in metal/glass product casting.

### SUMMARY OF THE INVENTION

Accordingly, in a first aspect, the present invention provides a calcium sulphate-based product comprising gypsum and silicone oil wherein the silicone oil is provided in an amount greater than 8.5 wt % (based on the weight of gypsum and silicone oil).

In a second aspect, the present invention provides a calcium sulphate-based product wherein the product is formed from drying an aqueous slurry containing calcined gypsum and silicone oil wherein the silicone oil is provided in an amount greater than 10 wt % (based on the weight of calcined gypsum and silicone oil).

In a third aspect, the present invention provides a method of forming a calcium sulphate-based product by drying an aqueous slurry comprising calcined gypsum and silicone oil wherein the silicone oil is provided in an amount greater than 10 wt % (based on the weight of calcined gypsum and silicone oil).

In a fourth aspect, the present invention provides the use of silicone oil (e.g. greater than 8.5 wt % silicone oil) for improving strength during heat exposure of a calcium sulphate-based product.

In a fifth aspect, the present invention provides a calcium sulphate-based composition for use in forming a calcium sulphate-based product by drying an aqueous slurry of the calcium sulphate-based composition, the calcium sulphate-based composition comprising calcined gypsum and silicone oil wherein the silicone oil is provided in an amount greater than 10 wt % (based on the weight of calcined gypsum and silicone oil).

The present inventors have found that adding more than 10 wt % of silicone oil in a calcined gypsum slurry produces (after drying) a calcium sulphate-based product having more than 8.5 wt % silicone oil which shows improved structural integrity at elevated temperatures.

The term “silicone oil” is intended to refer to liquid polysiloxanes. The silicone oil may comprise a polydiorganosiloxane. The organo groups may be alkyl and/or aryl e.g. methyl and/or phenyl groups. An example is polydimethylsiloxane (PDMS). The silicone oil may comprise a polyorganohydrosiloxane. The organo group may be an alkyl or aryl group e.g. a methyl and/or phenyl group. An example is polymethylhydrosiloxane (PMHS). The silicone oil may comprise a copolymer of a diorganosiloxane and an organohydrosiloxane or a blend of a polydiorganosiloxane and a polyorganohydrosiloxane.

The silicone oil may be anhydrous.

In the slurry used to form the calcium sulphate-based product and in the calcium sulphate-based composition, the silicone oil is preferably provided in an amount equal to or greater than 12.5 wt %, or equal to or greater than 15 wt %, or equal to or greater than 20 wt %, or equal to or greater than 25 wt % (where wt % is based on the weight of the calcined gypsum and silicone oil).

In the calcium sulphate-based product, the silicone oil is preferably provided in an amount equal to or greater than 10.7 wt %, or equal to or greater than 13.0 wt %, or equal to or greater than 17.4 wt % or equal to or greater than 22 wt % (where wt % is based on the weight of the calcined gypsum and silicone oil).

The term “gypsum” is intended to refer predominantly to calcium sulphate dihydrate (CaSO₄.2H₂O).

The term “calcined gypsum” is intended to refer predominantly to calcium sulphate hemihydrate (CaSO₄.½H₂O) but may also encompass any other calcium sulphate compound having a lower bound water content than calcium sulphate dihydrate (e.g. calcium sulphate anhydrite).

In the slurry used to form the calcium sulphate-based product and in the calcium sulphate-based composition, the calcined gypsum is preferably provided in an amount less than 95 wt %, e.g. less than 90 wt % or less than 88 wt % or less than 80 wt %. In the slurry/composition used to form the calcium sulphate-based product, the calcined gypsum is preferably provided in an amount greater than 60 wt %, e.g. greater than 65 wt %, greater than 70 wt % or greater than 75 wt % (where wt % is based on the weight of the calcined gypsum and silicone oil).

In the calcium sulphate-based product, the gypsum is preferably provided in an amount less than 95 wt %, e.g. less than 92 wt % or less than 90 wt % or less than 83 wt %. In the calcium sulphate-based product, the gypsum is preferably provided in an amount greater than 64 wt %, e.g. greater than 69 wt %, greater than 73 wt % or greater than 78 wt % (where wt % is based on the weight of the gypsum, and silicone oil).

In some embodiments, the calcium sulphate-based product may contain inorganic fibres (e.g. glass fibres) and/or matting (e.g. glass matting). For example, 0.3 to 1.0 wt % inorganic fibres may be added to the slurry (based on the weight of calcined gypsum and inorganic fibres.)

The calcium sulphate-based product may contain additives such as accelerators, retarders, foaming/anti-foaming agents, fluidisers etc. The accelerators may be, for example, freshly ground gypsum having an additive of sugar or surfactant. Such accelerators may include Ground Mineral NANSA (GMN), heat resistant accelerator (HRA) and ball milled accelerator (BMA). Alternatively, the accelerator may be a chemical additive such as aluminium sulphate, zinc sulphate or potassium sulphate. In certain cases, a mixture of accelerators may be used, e.g. GMN in combination with a sulphate accelerator. As a further alternative, ultrasound may be used to accelerate the setting rate of the slurry, e.g. as described in US2010/0136259.

The term “calcium sulphate-based product” may include building materials such as gypsum wallboards (with or without liners) (with or without fibrous reinforcement), tiles (e.g. ceiling tiles), duct encasement panels, joint filler materials (e.g. for joining adjacent wallboards/tiles/panels etc.), plaster composition or moulds for metal casting.

The calcium sulphate-based product may be a composite product e.g. it may be a wallboard having a gypsum matrix core (containing the clay and metal salt additives) sandwiched between two liners (e.g. paper liners or fibreglass matting).

The term “calcium sulphate-based” will be readily understood as meaning that the product comprises gypsum as a major component i.e. that gypsum is the largest single component in terms of wt % of the product. The term may mean that the product comprises gypsum in 40 wt %, 50 wt %, 60 wt %, 65 wt %, 70 wt %, 80 wt %, 90 wt % or greater based on the total weight of the product.

### EXPERIMENTAL

The following examples show products having improved strength after exposure to high temperatures and are given by way of illustration only.

The silicone oil used was SILRES® BS 94 provided by Wacker. This is an anhydrous silicone oil based on polymethylhydrosiloxane.

### Control Sample 1—6 wt % Silicone Oil

600 g of water at 40° C. was mixed with 3.75 g of John Mansville glass fibres and 45 g silicone oil. 750 g of calcined gypsum was added to the water and the mixture was mechanically blended for 10 seconds to form a slurry. A small amount of the slurry was poured into a 320 mm×120 mm×12.5 mm silicone mould and glass tissue was pressed into the slurry to the base of the mould. The remaining slurry was poured into the mould and further layer of glass tissue was laid onto the top of the slurry. The sample was dried at 40° C. overnight (minimum 12 hours).

### Control Sample 2—10 wt % Silicone Oil

600 g of water at 40° C. was mixed with 3.75 g of John Mansville glass fibres and 75 g silicone oil. 750 g of calcined gypsum was added to the water and the mixture was mechanically blended for 10 seconds to form a slurry. A small amount of the slurry was poured into a 320 mm×120 mm×12.5 mm silicone mould and glass tissue was pressed into the slurry to the base of the mould. The remaining slurry was poured into the mould and further layer of glass tissue was laid onto the top of the slurry. The sample was dried at 40° C. overnight (minimum 12 hours).

### EXAMPLE 1—12.5 WT %

600 g of water at 40° C. was mixed with 3.75 g of John Mansville glass fibres and 93.75 g silicone oil. 750 g of calcined gypsum was added to the water and the mixture was mechanically blended for 10 seconds to form a slurry. A small amount of the slurry was poured into a 320 mm×120 mm×12.5 mm silicone mould and glass tissue was pressed into the slurry to the base of the mould. The remaining slurry was poured into the mould and further layer of glass tissue was laid onto the top of the slurry. The sample was dried at 40° C. overnight (minimum 12 hours).

### EXAMPLE 2—25 WT % SILICONE OIL

600 g of water at 40° C. was mixed with 3.75 g of John Mansville glass fibres and 187.5 g silicone oil. 750 g of calcined gypsum was added to the water and the mixture was mechanically blended for 10 seconds to form a slurry. A small amount of the slurry was poured into a 320 mm×120 mm×12.5 mm silicone mould and glass tissue was pressed into the slurry to the base of the mould. The remaining slurry was poured into the mould and further layer of glass tissue was laid onto the top of the slurry. The sample was dried at 40° C. overnight (minimum 12 hours).

A summary of the sample formulations is shown in Table 1.

TABLE 1
Summary of sample formulations

| | Amount | | Amount | | Amount |
|---|---|---|---|---|---|
| | of stucco in | | of silicone oil in | | of silicone oil in |
| Sample | slurry/g (wt %) | | slurry/g (wt %) | | product/wt % |
| Control 1 | 750 | (94) | 45 | (6) | 5.1 |
| Control 2 | 750 | (90) | 75 | (10) | 8.5 |
| Example 1 | 750 | (87.5) | 93.75 | (12.5) | 10.7 |
| Example 2 | 750 | (75) | 187.5 | (25) | 22 |

### Collapse Test—Horizontal Fire Test

Samples (250 mm×50 mm) were placed in a furnace at room temperature with their ends supported such that the samples rested horizontally (span between support 210 mm). The samples were heated to 1000° C. over 1.5 hours and then allowed to cool to room temperature. The samples were assessed for collapse after cooling. The distance from the bottom of the sample to the base support was measured in mm. This value was subtracted from 50 mm to give a collapse measurement. The maximum possible collapse measurement (i.e. total collapse) is 50 mm and the minimum possible collapse measurement (i.e. no collapse) is 0 mm. The collapse measurements are shown in Table 2.

TABLE 2
Results of collapse test

| | Amount | Amount | | |
|---|---|---|---|---|
| | of silicone | of silicone | | |
| | oil in slurry | oil is product | | |
| | (in dried | (in dried | | |
| Sample | sample)/wt % | sample)/wt % | Collapse/mm | |
| Control 1 | 6 | 5.1 | Total collapse | |
| Control 2 | 10 | 8.5 | 15 | mm sag |
| Example | 12.5 | 10.7 | 10.5 | mm sag |
| 1 | | | | |
| Example | 25 | 22 | 9 | mm sag |
| 2 | | | | |

It can be seen that the addition of more than 10 wt % silicone oil in the slurry significantly improves the structural integrity of the sample.

1-27. (canceled)

28. A calcium sulphate-based product comprising gypsum and silicone oil wherein the silicone oil is provided in an amount greater than 8.5 wt %, where wt % is based on the weight of gypsum and silicone oil.

29. A calcium sulphate-based product according to claim 28, wherein the silicone oil is provided in an amount equal to or greater than 10.7 wt %, where wt % is based on the weight of the calcined gypsum and silicone oil.

30. A calcium sulphate-based product according to claim 28, wherein the gypsum is provided in an amount less than 92 wt %, where wt % is based on the weight of the gypsum, and silicone oil.

31. A calcium sulphate-based product according to claim 30, wherein the gypsum is provided in an amount greater than 64 wt %, where wt % is based on the weight of the gypsum, and silicone oil.

32. A calcium sulphate-based product wherein the product is formed from drying an aqueous slurry containing calcined gypsum and silicone oil wherein the silicone oil is provided in an amount greater than 10 wt %, where wt % is based on the weight of calcined gypsum and silicone oil.

33. A calcium sulphate-based product according to claim 32, wherein the silicone oil is provided in the slurry an amount equal to or greater than 12.5 wt %, where wt % is based on the weight of the calcined gypsum and silicone oil.

34. A calcium sulphate-based product according to claim 32, wherein the calcined gypsum is provided in the slurry in an amount less than 95 wt %, where wt % is based on the weight of the calcined gypsum, and silicone oil.

35. A calcium sulphate-based product according to claim 34, wherein the calcined gypsum is provided in the slurry in an amount greater than 60 wt %, where wt % is based on the weight of the calcined gypsum and silicone oil.

36. A calcium sulphate based product according to claim 28, further comprising between 0.3 and 1.0 wt % inorganic fibres, where wt % is based on the weight of the gypsum/calcined gypsum and inorganic fibres.

37. A calcium sulphate-based product according to claim 28, wherein the product is a gypsum wall board.

38. A calcium sulphate-based product according to claim 28, comprising 40 wt % of more gypsum based on the total weight of the product.

39. A calcium sulphate-based composition for use in forming a calcium sulphate-based product by drying an aqueous slurry of the calcium sulphate-based composition, the calcium sulphate-based composition comprising calcined gypsum and silicone oil wherein the silicone oil is provided in an amount greater than 10 wt %, where wt % is based on the weight of calcined gypsum and silicone oil.

40. A calcium sulphate-based composition according to claim 39, wherein the silicone oil is provided in an amount equal to or greater than 12.5 wt %, where wt % is based on the weight of the calcined gypsum and silicone oil.

41. A calcium sulphate-based composition according to claim 39, wherein the calcined gypsum is provided in an amount less than 95 wt %, where wt % is based on the weight of the calcined gypsum, and silicone oil.

42. A calcium sulphate-based composition according to claim 41, wherein the calcined gypsum is provided in an amount greater than 60 wt %, where wt % is based on the weight of the calcined gypsum and silicone oil.

43. A calcium sulphate-based composition according to claim 39, further comprising between 0.3 and 1.0 wt % inorganic fibres, where wt % is based on the weight of the calcined gypsum and inorganic fibres.

44. Use of silicone oil for improving strength during heat exposure of a calcium sulphate-based product.

45. Use according to claim 44, wherein the silicone oil is used in the calcium sulphate-based product in an amount greater than 8.5 wt %.

46. Use according to claim 44, wherein the calcium sulphate-based product is a gypsum wallboard.

47. Use according to claim 44, wherein the calcium sulphate-based product comprises 40 wt % or more gypsum based on the total weight of the product.
